(19) United States
(12) Patent Application Publication
(10) Pub. No.: US 2022/0221393 A1
(43) Pub. Date: Jul. 14, 2022

(54) Prediction Formula Derivation Method and Prediction Formula Derivation Apparatus

(71) Applicant: Nippon Telegraph and Telephone Corporation, Tokyo (JP)

(72) Inventors: Shingo Mineta, Musashino-shi, Tokyo (JP); Shota Oki, Musashino-shi, Tokyo (JP); Mamoru Mizunuma, Musashino-shi, Tokyo (JP); Masayuki Tsuda, Musashino-shi, Tokyo (JP)

(21) Appl. No.: 17/606,572

(22) PCT Filed: May 17, 2019
(86) PCT No.: PCT/JP2019/019673

§ 371 Date: Oct. 26, 2021

(51) Int. Cl. G01N 17/00; G06N 7/00

(52) U.S. Cl. CPC G01N 17/006; G06N 7/00

(57) ABSTRACT

In a prediction formula derivation apparatus, a calculation unit derives a prediction formula for predicting progression of corrosion of a metal based on a variation index resulting from a cyclical external factor that causes a predetermined environment (e.g., in air, underwater, underground, etc.) to vary, and a unit index obtained based on a value corresponding to the corrosion amount of the metal in the environment resulting from the external factor for one cycle.

### TECHNICAL FIELD

The present invention relates to a technique of deriving a prediction formula for predicting the progression of corrosion of a metal.

### BACKGROUND ART

Many underground facilities made of metal are used in infrastructure, as represented by steel tube columns, support anchors, underground steel pipes, and the like. Since underground facilities made of metal are used in a state in which all or a portion thereof is buried in the ground and is in contact with soil, the underground facilities corrode and deterioration progresses at different rates according to the underground environment (NPL 1).

However, since the underground environment cannot be visually observed and there is also little accumulation of knowledge, inspection data, and the like regarding corrosion, it is difficult to quantitatively evaluate and accurately predict the degree of progression of corrosion for each underground environment.

In view of this, examples of methods for predicting the progression of corrosion of an underground environment include a method of deriving a prediction formula for the progression of corrosion of an underground facility by statistically analyzing a value (target variable) corresponding to the amount of corrosion, such as the corrosion depth, which is obtained through inspection, on-site investigation, or the like, and an environmental factor (explanatory variable) such as geographical information or a chemical analysis value of soil that is thought to influence corrosion.

### CITATION LIST

### Non-Patent Literature

[NPL 1] Tsunoda, 1 other, “Perspective for Evaluating Corrosiveness of Soil”, Boshoku Gijyutsu, Vol. 36, No. 3, 1987, p. 168-177

### SUMMARY OF THE INVENTION

### Technical Problem

For example, items defined in ANSI or DVGW, which are soil corrosiveness evaluation standards, are often used as chemical analysis values of soil, such as the specific resistance, pH, Redox potential, water content, and the like of the soil. Also, for example, the type, soil property category, land use, distance from rivers and seas, and the like of the soil are used as the geographical information.

However, even if these environmental factors (explanatory variables) are subjected to direct correlative analysis with a value (target variable) corresponding to the corrosion amount of an underground facility, it is difficult to extract a favorable relationship and degree of association, and it is difficult to derive a prediction formula for the progression of corrosion with a high accuracy and reliability.

The reason why it is difficult is thought to be because many of the environmental factors used as explanatory variables are used as fixed values despite varying according to external factors such as weather conditions. For example, the water content of the soil, which is thought to have the most influence on corrosion, changes moment to moment depending on the influence of rainfall or the like. That is, since there is a significant difference between the environmental factor amount immediately after rainfall and the environmental factor amount after fair weather has continued for a long period, the relationship and the degree of association are expressed as different numerical values even if the varying environmental factor is subjected to direct correlative analysis with a measurement value (target variable) relating to the amount of corrosion.

In this manner, although many environmental factors such as chemical analysis values of the soil and geographical information include the influence of variation (fluctuation) caused by weather conditions and the like, they have been handled as averages, and therefore it has been difficult to derive a prediction formula for the progression of corrosion that fits reality, even if the environmental factors are subjected to direct analysis with a measurement value (target variable) relating to the amount of corrosion as an explanatory variable.

That is, as in the conventional method, there has been a problem in that it is difficult to predict the progression of corrosion that fits reality even if environmental factors (explanatory variables) such as geographical information and chemical analysis values of soil, which are thought to influence corrosion, such as the specific resistance, pH, Redox potential, and water content of soil, and a measurement value (target variable) relating to the amount of corrosion are subjected to direct correlative analysis.

The present invention was made in view of the above-described circumstances, and aims to provide a prediction formula derivation method and a prediction formula derivation apparatus that derive a prediction formula for the progression of corrosion that fits reality.

### Means for Solving the Problem

In order to resolve the above-described problem, a prediction formula derivation method of the present invention is a prediction formula derivation method for predicting progression of corrosion of a metal that is installed in an environment that changes cyclically, the method including a step of a prediction formula derivation apparatus deriving a prediction formula for predicting the progression of corrosion of the metal based on a variation index resulting from a cyclical external factor that causes an environment to vary, and a unit index obtained based on a value corresponding to a corrosion amount of the metal in the environment resulting from the external factor for one cycle.

In the above-described prediction formula derivation method, the step includes: a first step of inputting location information indicating an installation location of the metal; a second step of acquiring weather information of the installation location based on the location information; a third step of deriving the variation index based on the weather information; a fourth step of deriving the unit index based on the variation index; a fifth step of calculating a degree of association between the unit index and an environmental factor of the environment; and a sixth step of deriving the unit index relating to a predetermined said environmental factor based on the degree of association, and deriving the prediction formula based on the unit index.

In the above-described prediction formula derivation method, in the second step, rainfall information of the installation location is acquired as the weather information, in the third step, an index obtained based on rainfall information of one year at the installation location is derived as the variation index based on the rainfall information, and in the fourth step, an index corresponding to the corrosion amount for one instance of rainfall at the installation location is derived as the unit index based on the index obtained based on the rainfall information of one year.

In the above-described prediction formula derivation method, the prediction formula follows a power law formula, and a constant of proportionality included in the power law formula is a value corresponding to a value obtained by integrating the unit index for a predetermined number of cycles based on the variation index for one year.

In the above-described prediction formula derivation method, the power law formula is D=K×Tⁿ, where D is a measurement value of the corrosion amount of the metal, T is an elapsed year count, which is the number of years that have elapsed since the metal was installed in the environment, K is the constant of proportionality, and n is a constant.

In the above-described prediction formula derivation method, the external factor is rainfall.

Also, a prediction derivation apparatus of the present invention is a prediction formula derivation apparatus that includes an input unit, a calculation unit, and a display unit, and that is configured to predict progression of corrosion of a metal that is installed in an environment that changes cyclically, in which the input unit includes: an input function unit configured to input location information indicating an installation location of a metal in an environment; and an acquisition function unit configured to acquire weather information of the installation location based on the location information, the calculation unit includes: a first derivation function unit configured to derive a variation index resulting from a cyclical external factor that causes the environment to vary, based on the weather information; a second derivation function unit configured to derive a unit index obtained based on a value corresponding a corrosion amount of the metal in the environment resulting from the external factor for one cycle, based on the variation index; a calculation function unit configured to calculate a degree of association between the unit index and an environmental factor of the environment; and a third derivation function unit configured to derive the unit index relating to a predetermined said environmental factor based on the degree of association, and derive a prediction function for predicting the progression of corrosion of the metal based on the unit index, and the display unit includes a display function unit configured to display the prediction formula.

In the above-described prediction formula derivation apparatus, the input function unit further inputs a measurement value of the corrosion amount of the metal and an elapsed year count, which is the number of years that have elapsed since the metal was installed in the environment, the acquisition function unit acquires rainfall information of the installation location as the weather information, the first derivation function unit derives an index obtained based on rainfall information of one year at the installation location as the variation index, based on the rainfall information, assuming that a relationship between the measurement value D and the elapsed year count T follows a power law formula, which is D=K×Tⁿ (K being a constant of proportionality and n being a constant), the second derivation function unit calculates the constant of proportionality by substituting the input measurement value and the elapsed year count into the power law formula, and derives an index corresponding to a corrosion amount for one instance of rainfall at the installation location as the unit index, based on the constant of proportionality and the index obtained based on the rainfall information of one year, the calculation function unit calculates a degree of association between the index corresponding to the corrosion amount for one instance of rainfall and the environmental factor, and the third derivation function unit derives the index corresponding to the corrosion amount for one instance of rainfall relating to a predetermined said environmental factor based on the degree of association, and derives the prediction formula based on the index.

### Effects of the Invention

According to the present invention, it is possible to provide a prediction formula derivation method and a prediction formula derivation apparatus for deriving a prediction formula for the progression of corrosion that fits reality.

### BRIEF DESCRIPTION OF DRAWINGS

FIG. 1 is a diagram showing a functional block configuration of a prediction formula derivation apparatus.

FIG. 2 is a diagram showing a processing flow of a prediction formula derivation method.

FIG. 3 is a schematic view of a rainfall pattern.

FIG. 4 is a schematic view of a histogram of rainfall intervals.

FIG. 5 is a diagram showing a relationship between the corrosion rate of a metal and rainfall.

FIG. 6 is a schematic view of a unit corrosion function.

FIG. 7 is a diagram showing an example of fitting of a unit corrosion function.

FIG. 8 is a diagram showing an example of fitting of a unit corrosion function.

### DESCRIPTION OF EMBODIMENTS

Hereinafter, an embodiment for implementing the present invention will be described with reference to the drawings.

### Overview

The phenomenon of corrosion (wet corrosion) of a metal that occurs due to the influence of water leakage is an electrochemical reaction in which, basically, a lytic reaction (anode reaction) of a metal and a reduction reaction (cathode reaction) of a metal occur on the surface of the metal, even if the environment in which the metal is placed is a natural environment such as air, underwater, or underground. Accordingly, in the progression of corrosion, water and oxygen need to reach the outer surface of the metal, and the corrosion rate differs according to these states.

Rainfall is a representative element that changes the state of the water and oxygen on the outer surface of a metal in a natural environment. For example, metal that has been exposed to air is placed in a cycle environment that gets wet and dries with rainfall as a starting point, the cycle environment being one in which wetness starts together with rainfall and dryness is started at the same time as the rain stops. Even in the case of being underwater, at a portion or the like that is not always exposed to water, for example, a cycle environment is envisioned in which the portion gets wet due to the volume of the water increasing together with rainfall and dryness progresses when the rain stops. Although soil is an environment in which three phases, namely particles of sand, which are solids, gas that occupies gaps between particles, and water, co-exist, the inside of the soil is also a dry/wet-repeating cycle environment that gets wet together with rainfall and in which dryness is started at the same time as the rain stops.

When considered in this manner, it is possible to understand that the corrosion of metal in the natural environment progresses due to a cycle environment that gets wet and dries with rainfall as a starting point. Therefore, in the present embodiment, a prediction formula is derived considering that the underground environment in is a cycle environment that gets wet and dries with rainfall as a starting point.

Note that in the following embodiment, corrosion of metal in the underground environment (soil) will be described. However, the present invention is not limited to being applied to an underground environment. For example, the present invention can be applied to a case in which cyclical variation occurs, also in air, or underwater.

Here, it is assumed that identical metal bodies are buried for T years in a predetermined underground environment A and another underground environment B, and the corrosion amounts thereof are Qa and Qb respectively. When Qa<Qb is satisfied, it can be said that the corrosiveness of the other underground environment B is greater than the corrosiveness of the predetermined underground environment A. The corrosiveness of the underground environment in this context indicates an index that is strongly correlated with a value relating to the corrosion amount.

The corrosiveness of the underground environment is largely caused by the corrosiveness of the soil occupying the underground environment. However, even if the soil has a corrosiveness that is equal to the original corrosiveness, the influence that the soil has on the corrosion of the metal differs depending on the location at which the soil is present. This is thought to be because the corrosiveness of the underground environment in which the metal body is buried can change in a cyclical manner due to external factors such as weather conditions. For example, even if the metal is buried in an underground environment occupied by exactly the same soil, the corrosion amount of the metal differs depending on whether the soil is present in a region with high rainfall frequency or low rainfall frequency. For this reason, even if direct correlative analysis is performed with a measurement value relating to the corrosion amount, the relationship is expressed as different numerical values.

Many environmental factors such as chemical analysis values of the soil and geographical information, such as the specific resistance, pH, Redox potential, and water content of soil, which have generally been handled conventionally, have been handled as fixed values even though they are influenced by cyclical variation (fluctuation) caused by external factors such as weather conditions represented by rainfall. For this reason, it can be said that it is difficult to derive a prediction formula for progression of corrosion that fits reality even if the environmental factors are directly analyzed as explanatory variables with a measurement value (target variable) relating to the corrosion amount.

In view of this, when considered as stated above, when the prediction formula for the progression of corrosion is to be derived, it is thought that the prediction formula should be organized systematically by dividing into a variation index resulting from external factors, and a unit index. Here, external factors refer to weather conditions and the like that cause the underground environment to vary cyclically. Also, the unit index is obtained based on a value corresponding to a corrosion amount for one cycle, which is the smallest unit of cyclical change. Also, since the unit index is a value that is isolated by standardizing using a variation index resulting from external factors such as a weather condition, it is conceivable that a value corresponding to the corrosiveness of the soil itself, which does not depend on external factors, is obtained. Accordingly, the unit index is, for example, a value with a high correlation to the type of the soil, such as the soil group, the overall group, and the soil property category.

Because of this, the present invention discloses a prediction formula derivation method and a prediction formula derivation apparatus for deriving a prediction formula for predicting corrosion in a natural environment in which dryness and wetness are repeated cyclically due to external factors such as weather conditions represented by rainfall. The prediction formula is derived based on a variation index resulting from cyclical external factors such as weather conditions, and a unit index obtained based on a value corresponding to a corrosion amount of a target metal caused by external factors of one cycle.

Also, in the present embodiment, it is assumed that a value obtained by integrating the unit index obtained based on the value corresponding to the corrosion amount of the target metal according to the external factor for one cycle for a predetermined number of cycles based on the variation index resulting from the cyclical external factor such as weather conditions is equal to the corrosion amount of the target metal.

Also, in the present embodiment, the variation index resulting from the cyclical external factor such as the weather condition and the unit index obtained based on the value corresponding to the corrosion amount of the target metal resulting from the external factor of one cycle are derived separately using the following three pieces of information. The first piece of information is location information indicating an installation location of the target metal. The second piece of information is the elapsed year count, which is the number of years that have elapsed since the target metal was installed. The third piece of information is the value (corrosion amount measurement value) corresponding to the corrosion amount of the target metal. Also, the present embodiment calculates the prediction formula through a procedure of analyzing the relationship and degree of association between the unit index and the environmental factor (chemical analysis of soil, geographic information, etc., such as water content).

Accordingly, in the present embodiment, derivation of a prediction formula for progression of corrosion that matches reality is achieved.

### Procedure for Deriving Prediction Formula

In the present embodiment, it is assumed that progression of corrosion of a metal follows the power law. That is, letting D be the value relating to the corrosion amount of the metal and T be the elapsed year count, which is the number of years that have elapsed since the metal was installed, the value relating to the corrosion amount of the metal can be expressed as D=K×Tⁿ using a constant of proportionality K and a constant n.

In general, the constant of proportionality K is a constant that relies on the environment and is a value that significantly changes when the installation environment of the metal is changed. On the other hand, the constant n can be thought of as a constant that relies on the material, and for example, indicates a value of approximately 0.4 to 0.6 when iron or a steel material is buried in soil. Accordingly, the manner in which to express the constant of proportionality K will be the key to deriving the prediction formula for the progression of corrosion.

As stated above, the present embodiment derives a prediction formula for the purpose of predicting corrosion in a natural environment in which getting wet and drying are cyclically repeated due to external factors such as weather conditions represented by rainfall. Also, in the present embodiment, the prediction formula is constituted by a variation index resulting from cyclical external factors such as weather conditions and a unit index obtained based on the value corresponding to the corrosion amount of the metal caused by the external factor of one cycle.

Here, the constant of proportionality K corresponds to D when T=1 is satisfied, that is, the corrosion amount of an initial year. In the present embodiment, letting Q be the unit index, the corrosion amount of the initial year (=constant of proportionality K) is derived by integrating the unit index Q based on the variation index for one year. Accordingly, the constant of proportionality K can be expressed as K=ΣQ. For example, if rainfall is used as the external factor, the unit index Q corresponds to the corrosion amount of one instance of rainfall. Also, the value obtained by integrating the unit index Q based on a rainfall pattern for one year is thought to be equal to the constant of proportionality K.

That is, one example of a prediction formula derived in the present embodiment is expressed as shown in the following equation (1).

D=(ΣQ)×Tⁿ Equation (1)

At this time, the unit index Q may also be a value corresponding to the corrosion amount of one instance of rainfall, may also be expressed function-wise as the change over time in the corrosion amount of one instance of rainfall, and may also be expressed as the change over time in the corrosion rate of one instance of rainfall. The unit index Q of each rainfall need only be a value that corresponds to the corrosion amount of one cycle, and there is no particular limitation on the method of expressing the unit index Q.

Also, since the unit index Q is a value obtained by standardizing using a variation index, for example, the unit index Q is strongly correlated with environmental factors such as the soil particle diameter distribution and the type of the soil. Accordingly, by obtaining the relationship between the unit index Q and the environmental factors through multivariable analysis or the like and substituting the obtained relationship into equation (1), it is possible to derive a prediction formula for predicting a value relating to the corrosion amount of the metal based on the environmental factors such as the soil particle diameter distribution and the type of the soil, and the variation index of the target location.

### Prediction Formula Derivation Apparatus

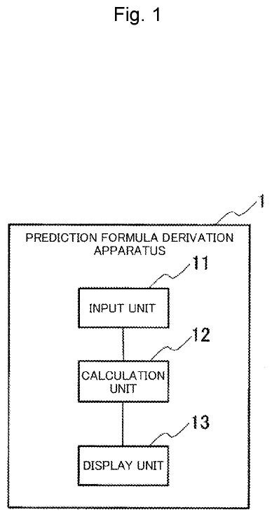

The present embodiment includes a prediction formula apparatus 1 shown in FIG. 1 in order to derive a prediction formula based on the above-described procedure. FIG. 1 is a diagram showing a functional block configuration of the prediction formula derivation apparatus 1 according to the present embodiment. The prediction formula derivation apparatus 1 is an apparatus for deriving a prediction formula for predicting progression of corrosion of a metal placed in soil so as to match reality, and for example, includes an input unit 11, a calculation unit 12, and a display unit 13. As described above, in the present embodiment, a case will be described in which the metal is in soil.

The input unit 11 includes, at least, an input function (input function unit) of inputting location information indicating the installation location of the metal in the soil, the number of years that have elapsed since the metal was installed in the soil, and a value (measurement value of the corrosion amount) relating to the corrosion amount of the metal.

Also, the input unit 11 includes an acquisition function (acquisition function unit) that acquires weather information of the installation location of the metal or the vicinity thereof based on the input location information. For example, the input unit 11 acquires rainfall information of the installation location of the metal as the weather information. The acquisition destination of the weather information is, for example, a weather information database managed by a weather bureau.

The calculation unit 12 includes a function (first derivation function unit) of deriving a variation index resulting from cyclical external factors that cause the environment in the soil to vary, based on the acquired weather information. For example, the calculation unit 12 calculates an index obtained based on rainfall information of one year at the installation location of the metal as the variation index based on the rainfall information.

Also, the calculation unit 12 includes a function (second derivation function unit) of deriving a unit index obtained based on the value corresponding to the corrosion amount of the metal in the soil resulting from external factors for one cycle based on the derived variation index. For example, it is assumed that the relationship between the measurement value D of the corrosion amount of the metal and the elapsed year count T of the metal in the soil follows a power law formula, which is D=K×Tⁿ (K being a constant of proportionality and n being a constant). In this case, the calculation unit 12 calculates the constant of proportionality K by substituting the measurement value D and the elapsed year count T input by the input unit 11 into the power law formula. Also, the calculation unit 12 derives an index corresponding to the corrosion amount for one instance of rainfall at the installation location as a unit index based on the constant of proportionality K and the index obtained based on the rainfall information of one year.

Also, the calculation 12 includes a function (calculation function unit) of analyzing the relationship between the derived unit index and the environmental factor relating to the environment of the soil. For example, the calculation unit 12 calculates the degree of association between the index corresponding to the corrosion amount of one instance of rainfall and the environmental factor.

Also, the calculation unit 12 includes a function (third derivation function unit) of deriving a unit index corresponding to the predetermined environmental factor based on the analyzed analysis result, and deriving a prediction formula (prediction formula obtained based on the power law formula) for predicting the progression of corrosion of the metal based on the unit index. For example, the calculation unit 12 derives the index corresponding to the corrosion amount for one instance of rainfall relating to the environmental factor with the highest degree of association based on the calculated degree of association, and derives the prediction formula based on the index.

The display unit 13 includes a function (display function unit) of displaying information such as the input value of the location information and the like input and acquired by the input unit 11, and the weather information, and the calculation result of the prediction formula and the like obtained by the calculation unit 12.

The prediction formula derivation apparatus 1 according to the present embodiment can be realized using a computer including a CPU, a memory, an input/output interface, a communication interface, and the like, and a monitor. It is also possible to create a prediction formula derivation program for causing a computer to function as the prediction formula derivation apparatus 1, and a storage medium for the prediction formula derivation program. However, there is no particular limitation on the functional configuration, external form, and the like of the input unit 11, the calculation unit 12, and the display unit 13.

### Procedure for Deriving Prediction Formula

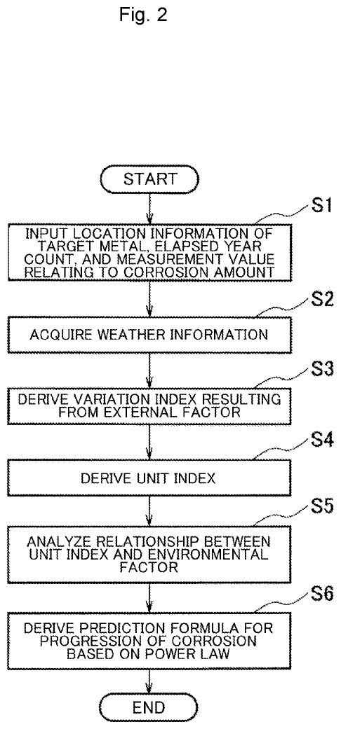

FIG. 2 is a diagram showing a processing flow of a prediction formula derivation method performed by the prediction formula derivation apparatus 1.

In the prediction formula derivation method of the present embodiment, the prediction formula derivation apparatus 1 performs a first step (S1), a second step (S2), a third step (S3), a fourth step (S4), a fifth step (S5), and a sixth step (S6). In the first step, the prediction formula derivation apparatus 1 inputs location information indicating an installation location of a target metal, the elapsed year count, which is the number of years that have elapsed since the target metal was installed in the soil, and a value (measurement value of the corrosion amount) relating to the amount of corrosion of the target metal. In the second step, the prediction formula derivation apparatus 1 acquires weather information for the installation location of the target metal or the vicinity thereof based on the input location information. In the third step, the prediction formula derivation apparatus 1 derives the variation index resulting from external factors such as weather conditions at the installation location of the target metal based on the acquired weather information. In the fourth step, the prediction formula derivation apparatus 1 derives the unit index obtained based on the value corresponding to the corrosion amount for one cycle based on the variation index resulting from the derived external factor. In the fifth step, the prediction formula derivation apparatus 1 analyzes the relationship between the derived unit index and the environmental factors such as the analysis value and the geographical information of the soil that are envisioned as influencing the corrosion. In the sixth step, the prediction formula derivation apparatus 1 constructs a prediction formula obtained based on the power law formula, based on the analyzed relationship.

### First Step (S1)

First, the input unit 11 of the prediction formula derivation apparatus 1 inputs the location information indicating the installation location of the target metal, the elapsed year count T of years that have elapsed since the target metal was installed in the soil, and the value (measurement value of the corrosion amount) D relating to the corrosion amount of the target metal.

Although there is no particular limitation on the type input as the location information of the target metal and the accuracy, it is preferable that the position of the target metal can be understood as accurately as possible, and therefore, for example, longitude/latitude information and orthogonal coordinate system information are used. The elapsed year count of the target metal is the number of years that have elapsed since the target facility of the metal was installed at the predetermined location. There is no particular limitation on the dimension of the measurement value relating to the corrosion amount of the target metal, the measurement position of the target metal, the measurement method, and the like. However, since it needs to be a numerical value obtained by quantitatively expressing the degree of corrosion of the target metal, for example, the corrosion depth and the like are measured. Note that the method of inputting the location information and the like may also be a method in which, for example, an input field is displayed on a monitor to cause a user to perform input using a keyboard, and may also be a method in which the data value of location information and the like are loaded.

### Second Step (S2)

Next, the input unit 11 acquires the weather information of the installation location of the target metal or the vicinity thereof from a weather information database or the like on the Internet based on the location information input in the first step.

Although there is no particular limitation on the type and the amount of information acquired as the weather information, for example, the input unit 11 acquires rainfall information of at least one year. The rainfall information at this time may be hourly rainfall or daily rainfall, and there is no particular limitation thereon. For example, if the location information is known, it is possible to use public rainfall data of the closest weather observation bureau. Radar-AMeDAS information or the like may also be used.

If there is no closest rainfall information, the input unit 11 may also use public rainfall data of two or more weather observation bureaus in order of how near they are to the installation location, for example, and may also generate simulated rainfall information assuming that the installation location is the average of those pieces of public rainfall data.

Also, when the rainfall information of one year is to be acquired, there is also no particular limitation on when the one-year period of the rainfall information starts and ends. For example, the input unit 11 may also acquire the one-year worth of rainfall information of an analyzed year, and may also acquire the one-year worth of rainfall information of the year in which the target facility of metal was buried. Also, even if one year's-worth of data cannot be acquired and, for example, there is only several months'-worth of data, the input unit 11 may also expand the data to one year's-worth of rainfall data assuming that rainfall has continued at the same rainfall frequency as in those several months. In addition, the input unit 11 may also acquire, for example, temperature information or the like in addition to the one year's-worth of rainfall information as the weather information.

### Third Step (S3)

Next, the calculation unit 12 derives the variation index resulting from the external factors such as the weather conditions at the installation location of the target metal based on the weather information acquired in the second step.

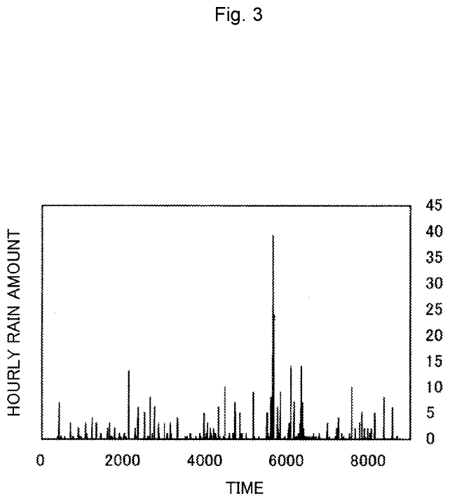

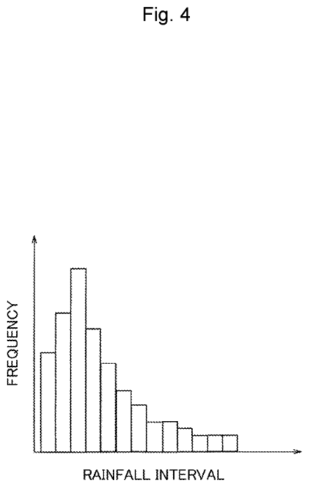

Although there is no particular limitation on the format and the like of the variation index resulting from the external factors, they depend on the information acquired in the second step. For example, if the input unit 11 acquires the change in the amount of hourly rainfall for one year, the calculation unit 12 may also use the rainfall pattern (FIG. 3) corresponding to the change in the amount of hourly rainfall for one year as a variation index. In addition, the calculation unit 12 may also calculate rainfall intervals and a histogram of the frequency thereof based on the rainfall pattern resulting from change in the amount of hourly rainfall for one year, and may use the histogram (FIG. 4) as the variation index.

Note that the calculation unit 12 may also provide a threshold value to the rain amount and adjust the threshold value for the histogram. For example, the calculation unit 12 may also create a histogram of intervals of the rainfall by counting rainfall of 1 mm or more with the hourly rain amounts. Also, if the input unit 11 has acquired temperature information other than the rainfall information, the calculation unit 12 can also add an index resulting from the temperature variation of one year, or an index obtained by converting into underground temperature variation based on the temperature variation of one year.

### Fourth Step (S4)

Next, the calculation unit 12 derives the unit index obtained based on the value corresponding to the corrosion amount of one cycle based on the fluctuation index resulting from external factors derived in the third step.

There is also no particular limitation on the format of the unit index. The unit index is the smallest unit of a cycle repetition, and indicates an index standardized using the variation index resulting from external factors such as environmental conditions. One example of the derivation method for the unit index is as follows.

First, the calculation unit 12 derives the histogram of the rainfall interval as the variation index resulting from the external factors. If the histogram has been derived in the third step, the calculation unit 12 may also use the histogram as-is.

Next, it is assumed that the relationship between the measurement value D relating to the corrosion amount and the elapsed year count T follows D=K×Tⁿ, which is a power law formula. In this case, the calculation unit 12 substitutes the measurement value D and the elapsed year count T input by the input unit 11 in the first step into the power law formula, further inputs the appropriate numerical value into the constant n, and solves K=D/Tⁿ, thereby calculating the constant of proportionality K. At this time, although there is no particular limitation on the numerical value input to the constant n, it is thought that the numerical value is generally a constant relating to the material of the target facility, and therefore in the case of iron or a steel material, it is a value of about 0.4 to 0.6. In addition, for example, a reference value may also be used as the numerical value input into the constant n, and if there is a long-term test result, a value obtained based on the test result may also be input.

Next, the calculation unit 12 calculates the index (unit index) corresponding to the corrosion amount of one instance of the rainfall using the histogram of the above-described rainfall interval and the above-described constant of proportionality K.

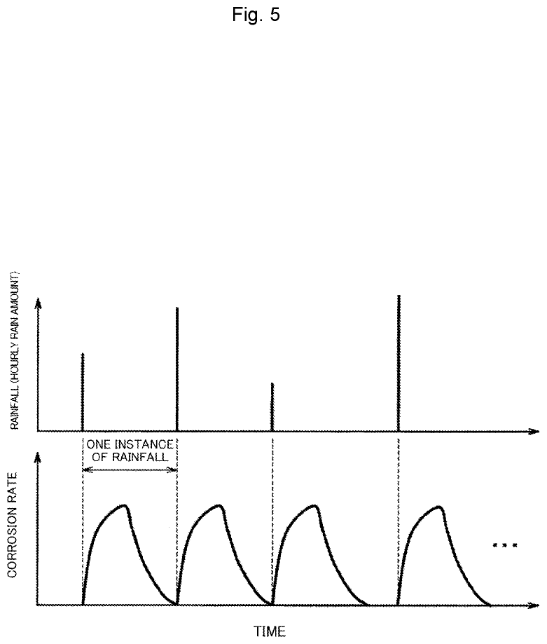

Here, the constant of proportionality K is equal to D obtained when T=1 is substituted into the power law formula and corresponds to the corrosion amount obtained when buried for one year in a predetermined environment. In the present embodiment, it is thought that the underground environment is a cycle environment that gets wet and dries with rainfall as a starting point, and therefore as shown in FIG. 5, the corrosion of the metal in the underground environment can be thought to be a cyclical change that repeats originating at rainfall, with the corrosion corresponding to one instance of rainfall serving as one smallest unit.

Obviously, the corrosion of the initial instance of rainfall upon being buried differs from the corrosion of one instance of rainfall after several tens of years, and the corrosion rate after several tens of years is smaller than the initial period, but attenuation of corrosion over time is handled by the above-described constant n. For this reason, in the present embodiment, the corrosion behavior for one instance of rainfall in the initial year may be thought of as being always the same.

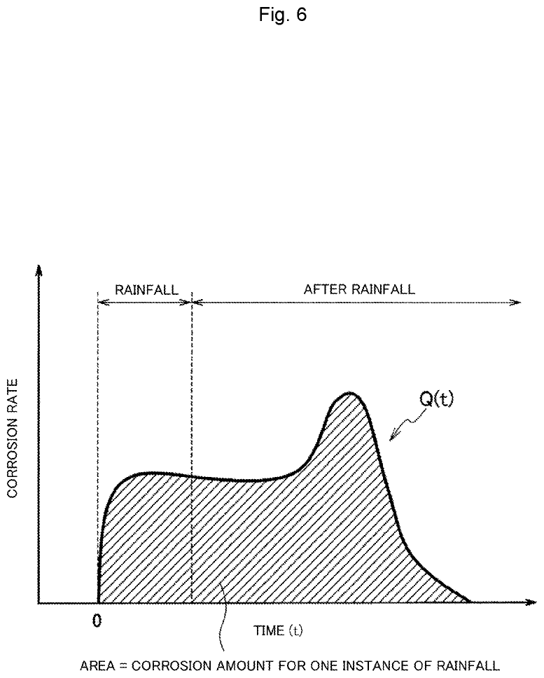

For example, the calculation unit 12 uses the change over time in the corrosion rate with respect to one instance of rainfall, which is the smallest unit, as the unit corrosion function q(t). According to our previous study, it has been understood that when the corrosion rate is indicated on a vertical axis and time is indicated on a horizontal axis, the unit corrosion function q(t) is a function shown in FIG. 6 (model function). t=0 is the rainfall start time, and the area taken up by the curved line corresponds to the corrosion amount of one instance of rainfall.

As described above, it is assumed that the constant of proportionality K corresponds to the corrosion amount of the initial year, and furthermore, the corrosion of the initial year occurs such that the unit corrosion function q(t) is repeated with rainfall as the starting point. Upon doing so, it is conceivable that a value obtained by integrating a unit corrosion function with the time interval of rainfall, that is, a value obtained by integrating ∫q(t)dt (=Q) following the histogram of the rainfall interval, is equal to the constant of proportionality K (=ΣQ).

Herein, Q=∫q(t)dt, which is the time-integrated value of the unit corrosion function, has a different value depending on the time interval when integrating. That is, letting the time interval of the N-th instance of rainfall and the N+1-th instance of rainfall in the rainfall pattern for one year be T_{N}, the value of (Q=∫q(t)dt) is a value obtained by time-integrating the unit corrosion function q(t) from t=0 to T_{N}. For this reason, for example, when T_{N}≠T_{N+1}, the value Q_{N+1} of (∫q(t)dt) when the time interval is T_{N+1} is different from the value of Q_{N} of (∫q(t)dt) when the time interval is T_{N}. That is, this means that K=ΣQ=Q₀+Q₁+Q₂+Q_{N}+Q_{N+1}+ . . . is satisfied.

In the present embodiment, q(t) is derived by solving the equation K=ΣQ based on this kind of idea, that is, by substituting the above-described K into the equation of K=ΣQ and solving the equation using the histogram of the above-described rainfall intervals.

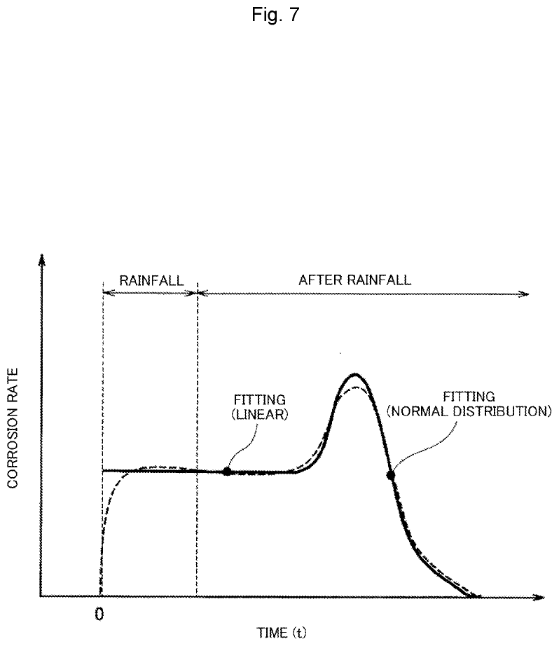

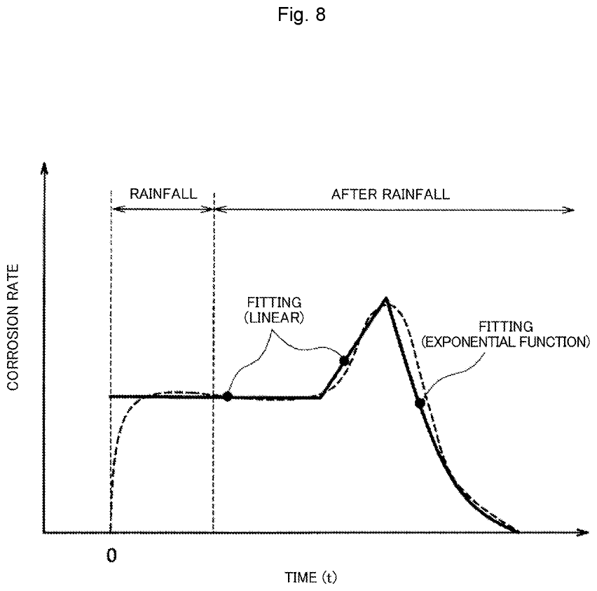

Note that it is preferable that the specific derivation method of the unit corrosion function q(t) is calculated assuming that q(t) follows a predetermined function. Although there is no particular limitation on the function of q(t), for example, as shown in FIG. 7, it may be constituted by two functions, namely a linear function and a regular distribution, which extend along the model function shown in FIG. 6, and it may be constituted by two linear functions and one exponential function as shown in FIG. 8. Although the unit corrosion function q(t) specified in this manner may also be a unit index, and the integrated value (Q=∫q(t)dt) up to the predetermined time of the unit corrosion function q(t) may also be the unit index.

### Fifth Step (S5)

Next, the calculation unit 12 analyzes the relationship between the unit index derived in the fourth step and the environmental factor such as the geographical information of the analysis value of the soil that are envisioned as influencing the corrosion.

Although there is no particular limitation on the environmental factor, for example, the environmental factor is selected from categories such as the soil group and the soil system group, and categories based on the size of the soil particles, such as the soil particle diameter distribution and the soil property category information. Furthermore, distinguishing of whether or not the ground surface is bare soil, distinguishing of whether or not the ground surface has been paved with asphalt or concrete, and geographical information such as the distance from a river and altitude are conceivable as examples of environmental factors.

The calculation unit 12 analyzes the relationship between these environmental factors and the unit corrosion function q(t), which is the unit index, or integral value (Q=∫q(t)dt) up to the predetermined time of the unit corrosion function q(t), using multivariable analysis or the like. That is, the calculation unit calculates the degree of association between the multiple environmental factors and the unit index. Then, the calculation unit 12 determines and extracts an environmental factor that has a high correlation and is to be used in the prediction formula, based on the analysis result of the relationship (calculation result of the degree of association).

### Sixth Step (S6)

Finally, the calculation unit 12 constructs a prediction formula obtained based on the power law formula, based on the relationship analyzed in the fifth step. That is, the calculation unit 12 uses the environmental factors extracted in the fifth step to construct a prediction formula obtained based on D=K×Tⁿ, which is the power law formula.

For example, if there is a high correlation between the unit corrosion function q(t) and the soil type or the soil particle diameter distribution, which is the environmental factor, the calculation unit 12 derives a relation equation for obtaining the unit corrosion function q(t) from the soil type and the soil particle diameter distribution that have a high correlation. The constant of proportionality K corresponds to a time-integrated value of the unit corrosion function q(t), that is, a value obtained by integrating Q=∫q(t)dt over one hour based on the rainfall information of a one-hour period at the target location (e.g., a histogram of rainfall intervals). Due to this, it is possible to derive a relation equation for deriving the constant of proportionality K from the soil type and the soil particle diameter distribution. For this reason, it is possible to construct a prediction formula that can be expressed as shown in equation (2) by substituting the relation equation into the power law equation.

D=(ΣQ)×Tⁿ={Σ(∫q(t)dt)}×Tⁿ Equation (2)

Note that q(t) is a unit corrosion function q(t) that relates to the soil type and the soil particle diameter distribution. If the assumed values of the soil type, the soil particle diameter distribution, and the elapsed year count T are input into the prediction formula of the equation (2), the measurement value D relating to the corrosion amount of the metal at the prediction location can be predicted.

### Effect

According to the present embodiment, a prediction formula for predicting the progression of corrosion of the metal is derived based on the variation index resulting from the cyclical external factor that causes the environment in the soil to vary, and the unit index obtained based on the value corresponding to the corrosion amount of the metal in the soil resulting from the external factor of one cycle. For this reason, it is possible to provide a prediction formula derivation method and a prediction formula derivation apparatus for deriving a prediction formula for the progress of corrosion that fits reality.

### REFERENCE SIGNS LIST

1 Prediction formula derivation apparatus
11 Input unit
12 Calculation unit
13 Display unit

1. A prediction formula derivation method for predicting progression of corrosion of a metal that is installed in an environment that changes cyclically, the method comprising a step of a prediction formula derivation apparatus deriving a prediction formula for predicting the progression of corrosion of the metal based on a variation index resulting from a cyclical external factor that causes an environment to vary, and a unit index obtained based on a value corresponding to a corrosion amount of the metal in the environment resulting from the external factor for one cycle.

2. The prediction formula derivation method according to claim 1, wherein the step includes:
a first step of inputting location information indicating an installation location of the metal;
a second step of acquiring weather information of the installation location based on the location information;
a third step of deriving the variation index based on the weather information;
a fourth step of deriving the unit index based on the variation index;
a fifth step of calculating a degree of association between the unit index and an environmental factor of the environment; and
a sixth step of deriving the unit index relating to a predetermined said environmental factor based on the degree of association, and deriving the prediction formula based on the unit index.

3. The prediction formula derivation method according to claim 2, wherein in the second step, rainfall information of the installation location is acquired as the weather information, in the third step, an index obtained based on rainfall information of one year at the installation location is derived as the variation index based on the rainfall information, and in the fourth step, an index corresponding to the corrosion amount for one instance of rainfall at the installation location is derived as the unit index based on the index obtained based on the rainfall information of one year.

4. The prediction formula derivation method according to claim 1, wherein the prediction formula follows a power law formula, and a constant of proportionality included in the power law formula is a value corresponding to a value obtained by integrating the unit index for a predetermined number of cycles based on the variation index for one year.

5. The prediction formula derivation method according to claim 4, wherein the power law formula is D=K×Tⁿ, where D is a measurement value of the corrosion amount of the metal, T is an elapsed year count, which is the number of years that have elapsed since the metal was installed in the environment, K is the constant of proportionality, and n is a constant.

6. The prediction formula derivation method according to claim 1, wherein the external factor is rainfall.

7. A prediction formula derivation apparatus that includes an input unit, a calculation unit, and a display unit, and that is configured to predict progression of corrosion of a metal that is installed in an environment that changes cyclically,
wherein the input unit includes:
an input function unit configured to input location information indicating an installation location of a metal in an environment; and
an acquisition function unit configured to acquire weather information of the installation location based on the location information,
the calculation unit includes:
a first derivation function unit configured to derive a variation index resulting from a cyclical external factor that causes the environment to vary, based on the weather information;
a second derivation function unit configured to derive a unit index obtained based on a value corresponding a corrosion amount of the metal in the environment resulting from the external factor for one cycle, based on the variation index;
a calculation function unit configured to calculate a degree of association between the unit index and an environmental factor of the environment; and
a third derivation function unit configured to derive the unit index relating to a predetermined said environmental factor based on the degree of association, and derive a prediction function for predicting the progression of corrosion of the metal based on the unit index, and
the display unit includes a display function unit configured to display the prediction formula.

8. The prediction formula derivation apparatus according to claim 7, wherein the input function unit further inputs a measurement value of the corrosion amount of the metal and an elapsed year count, which is the number of years that have elapsed since the metal was installed in the environment, the acquisition function unit acquires rainfall information of the installation location as the weather information, the first derivation function unit derives an index obtained based on rainfall information of one year at the installation location as the variation index, based on the rainfall information, assuming that a relationship between the measurement value D and the elapsed year count T follows a power law formula, which is D=K×Tⁿ (K being a constant of proportionality and n being a constant), the second derivation function unit calculates the constant of proportionality by substituting the input measurement value and the elapsed year count into the power law formula, and derives an index corresponding to a corrosion amount for one instance of rainfall at the installation location as the unit index, based on the constant of proportionality and the index obtained based on the rainfall information of one year, the calculation function unit calculates a degree of association between the index corresponding to the corrosion amount for one instance of rainfall and the environmental factor, and the third derivation function unit derives the index corresponding to the corrosion amount for one instance of rainfall relating to a predetermined said environmental factor based on the degree of association, and derives the prediction formula based on the index.
